(19) United States
(12) Patent Application Publication
(10) Pub. No.: US 2017/0061496 A1
(43) Pub. Date: Mar. 2, 2017

(54) GROUP-FOCUSED VIDEO OUTPUT

(71) Applicant: International Business Machines Coporation, Armonk, NY (US)

(72) Inventors: Fang Liang Dong, SHANGHAI (CN); Kevin T. Grignon, Chelsea (CA); Chang Lei, SHANGHAI (CN); Dong Ni, SHANGHAI (CN); Xin Wen Qi, Shanghai (CN); Yi Ping Qu, SHANGHAI (CN); Fei Sun, SHANGHAI (CN)

(21) Appl. No.: 14/838,574

(22) Filed: Aug. 28, 2015

(51) Int. Cl. G06Q 30/02

(52) U.S. Cl. CPC G06Q 30/0269

(57) ABSTRACT

One or more processors determine a common interest associated with a group of individuals based, at least in part, on one or more interests associated with individuals within the group of individuals. One or more processors determine a video output to display to the group of individuals. The video output is anticipated to appeal to at least a portion of the group of individuals based, at least in part, on the common interest associated with the group of individuals. One or more processors display the video output to the group of individuals.

### BACKGROUND OF THE INVENTION

The present invention relates generally to the field of customized video output, and more particularly to group-focused video output.

Advances in audio/video technology have led to an increasing number of video displays in public venues. The video displays output content such as entertainment and advertisements to groups of individuals frequenting places such as transportation hubs (e.g. airports, train stations, bus stations, etc.), entertainment venues (e.g. casinos, sports and entertainment arenas, etc.), and shopping venues (e.g. malls, department and grocery stores, etc.).

Typically, video displays in public venues are positioned such that the public can readily view the output video content. For example, video displays are often positioned in front of seating areas, alongside people-movers or escalators, above areas where foot traffic is heavy, etc. As mentioned above, the content shown is typically entertainment-based, advertisement-based, or both. The purpose of said content is often to either keep the viewers in the venue where the display is deployed or compel the viewer to visit another site in order to, for example, shop, play, or view a show.

### SUMMARY

Embodiments of the present invention provide a method, system, and program product to provide group-focused video output. One or more processors determine a common interest associated with a group of individuals based, at least in part, on one or more interests associated with individuals within the group of individuals. One or more processors determine a video output to display to the group of individuals, wherein the video output is anticipated to appeal to at least a portion of the group of individuals based, at least in part, on the common interest associated with the group of individuals. One or more processors display the video output to the group of individuals.

### BRIEF DESCRIPTION OF THE SEVERAL VIEWS OF THE DRAWINGS

FIG. 1 is a functional block diagram illustrating a group-focused video output environment, in accordance with an exemplary embodiment of the present invention.

FIG. 2 illustrates operational processes for displaying video outputs to a group of individuals based on their common interests, on a computing device within the environment of FIG. 1, in accordance with an exemplary embodiment of the present invention.

FIG. 3 illustrates operational processes for determining the common interests associated with a group of individuals, on a computing device within the environment of FIG. 1, in accordance with an exemplary embodiment of the present invention.

FIG. 4 illustrates operational processes for prioritizing the video outputs displayed to the group, on a computing device within the environment of FIG. 1, in accordance with an exemplary embodiment of the present invention.

FIG. 5 depicts a block diagram of components of the computing device executing a video output program, in accordance with an exemplary embodiment of the present invention.

### DETAILED DESCRIPTION

The selection of video output displayed in public venues is often governed by a preconceived idea of who the audience will be. Thus, market research predicts what demographics will dominate the audience and repetitive video content is shown that is anticipated to appeal to that demographic. However, in other scenarios and approaches, video output, displayed in public venues, is output that contains personalized content for individuals. In yet other cases, the selection of video output may be determined by the goods and services that are available in nearby proximity to the video display. For example, video output from a display near a sporting goods store shows sporting goods that are available and on sale at that sporting goods store.

Referring now to video output, displayed in public venues, that contains personalized content for individuals. In these scenarios, content reflecting the personal interests of an individual is shown when that individual is watching the video display. Public display of such content may cause discomfort for the individual because a situation may be created whereby private information about the individual is being publicly disseminated. For example, a personalized advertisement for a medical treatment that treats a specific therapeutic need informs every passer-by that the person viewing the advertisement likely has that therapeutic need.

Embodiments of the present invention provide video output that focuses on the common, shared interests of a group. Embodiments of the present invention allow the providers of video outputs to display content that is more relevant to the audience than demographic-based content, but preserves the privacy of the individuals within that group.

The present invention will now be described in detail with reference to the Figures.

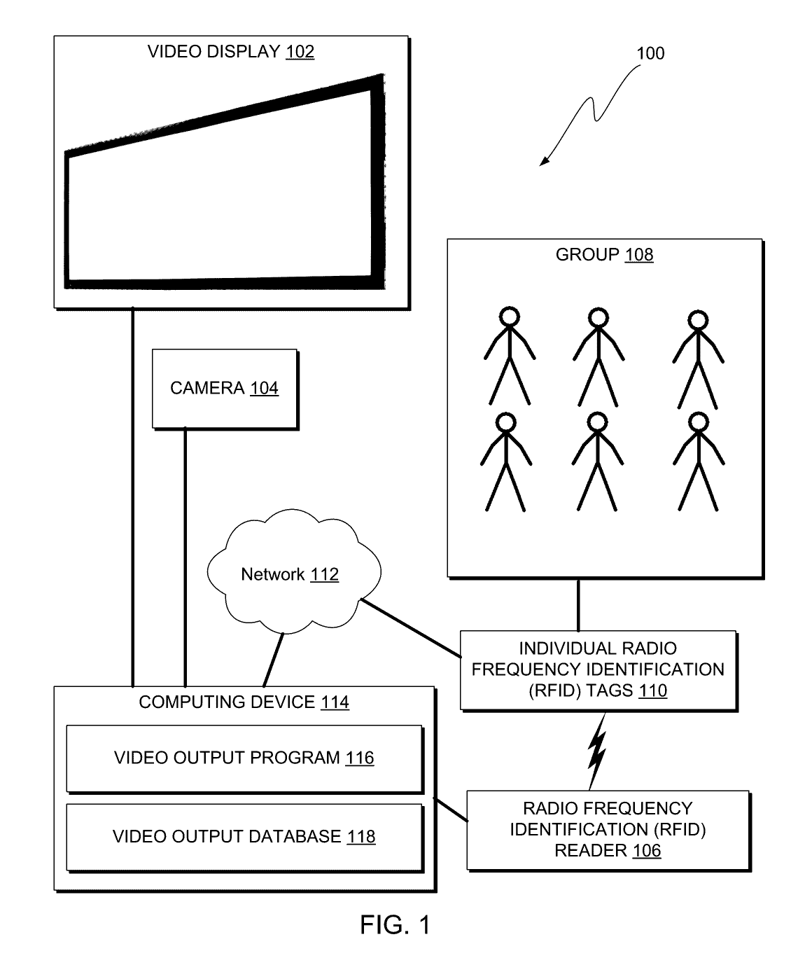

FIG. 1 is a functional block diagram illustrating a group-focused video output environment, generally designated 100, in accordance with one embodiment of the present invention. Group-focused video output environment 100 includes video display 102, camera 104, and radio frequency identification (RFID) reader 106 connected to computing device 114. Computing device 114 and individual RFID tags 110 are connected over network 112. Computing device 114 includes video output program 116 and video output database 118.

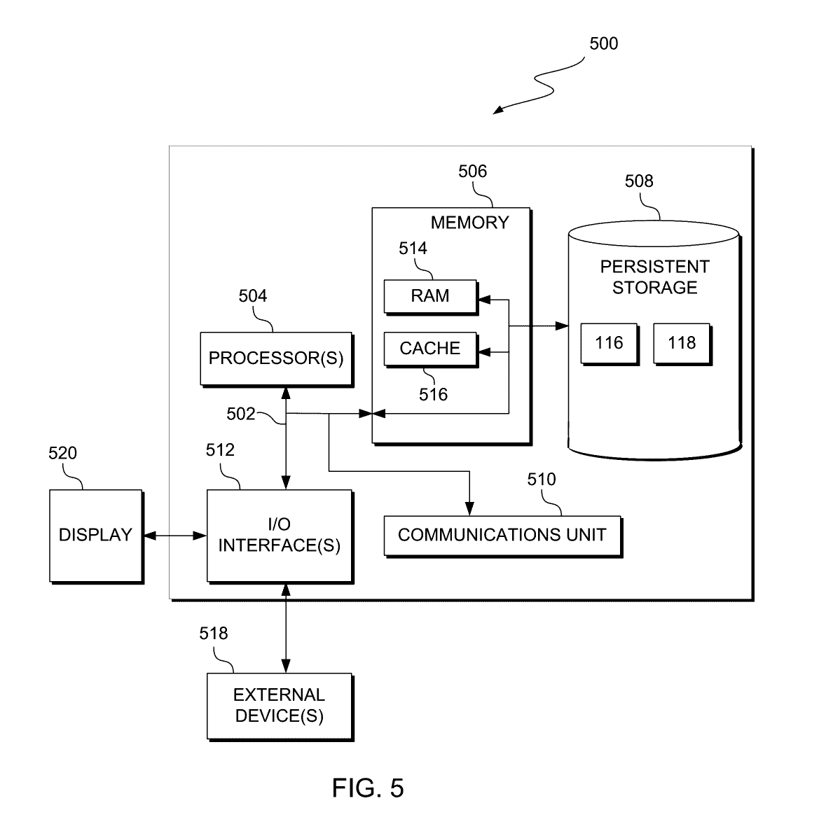

In various embodiments of the present invention, computing device 114 is a computing device that can be a standalone device, a server, a laptop computer, a tablet computer, a netbook computer, a personal computer (PC), or a desktop computer. In another embodiment, computing device 114 represents a computing system utilizing clustered computers and components to act as a single pool of seamless resources. In general, computing device 114 can be any computing device or a combination of devices with access to video display 102, camera 104, RFID reader 106, video output database 118, and network 112 and is capable of executing video output program 116. Computing device 114 may include internal and external hardware components, as depicted and described in further detail with respect to FIG. 5.

In this exemplary embodiment, video output program 116 and video output database 118 are stored on computing device 114. However, in other embodiments, video output program 116 and video output database 118 may be stored externally and accessed through a communication network, such as network 112. Network 112 can be, for example, a local area network (LAN), a wide area network (WAN) such as the Internet, or a combination of the two, and may include wired, wireless, fiber optic or any other connection known in the art. In general, network 112 can be any combination of connections and protocols that will support communications between video display 102, camera 104, RFID reader 106, video output database 118, individual RFID tags 110, and video output program 116, in accordance with a desired embodiment of the present invention.

In exemplary embodiments, video display 102 is a video display such as those found in any public venue such as, for example, transportation hubs (e.g. airports, train stations, bus stations, etc.), entertainment venues (e.g. casinos, sports and entertainment arenas, etc.), and shopping venues (e.g. malls, department and grocery stores, etc.). Video displays such as video display 102 are often positioned in front of seating areas, alongside people-movers or escalators, above areas where foot traffic is heavy, etc. The content shown is typically entertainment-based, advertisement-based, or both. The purpose of said content is often to either keep the viewers in the venue where the display is deployed or compel the viewer to visit another site in order to, for example, shop, play, or view a show.

In exemplary embodiments, camera 104 is a camera such as those used for surveillance and biometrics (e.g. facial recognition, body movement, etc.). In various embodiments, camera 104 is positioned so as to be able to determine whether the individuals, within group 108, are interested in the video content being shown on video display 102. Interest by individuals within group 108 is, in general, indicated by body language such as, for example, staring at video display 102. In some cases, combinations of body language indicate the interest of the individual within group 108. For example, a level of interest of an individual is determined based on that individual slowing down and staring at video display 102.

In general, group 108 is a group of individuals that are i) capable of perceiving media content from a media source, e.g., video display 102, and ii) are associated with a device that indicates, either passively or directly, the interests of an individual included in group 108, e.g., a mobile device such as a cellular phone or a mobile computing device. For example, a mobile phone is made by a specific company, therefore the individual is determined, passively, to have interests in one or both of a) cell phones and b) products of that company. In another example, the mobile phone includes a data file that indicates the interests of the individual and this data is accessible by another party, such as video output program 116, i.e., the data file expressly indicates the interests of the individual to video output program 116. In general, the device associated with an individual is a data storage device in communication with video output program 116. Further, the data included by such a data storage device enables video output program 116 to determine the interests of the individual with which the data storage device is associated.

In exemplary embodiments described herein, group 108 is a group of individuals that are i) capable of seeing video output from video display 102, and ii) who are also associated with one or more individual RFID tags 110. Individual RFID tags 110 are powered in any of the ways well-known in the art (e.g., passive, active, battery-assisted passive, etc.). Individual RFID tags 110 include data that is read by RFID reader 106. In various embodiments, individual RFID tags 110 contain anywhere between 96 bits up to 2 kilobytes (KB) of data. Data that is stored on individual RFID tags 110 and read by RFID reader 106 allows video output program 116 to determine the interests of an individual that is associated with a particular individual RFID tag.

In exemplary embodiments, video output program 116 determines what individuals in a crowd comprise group 108 based on several possible factors such as where they are positioned and whether they can see video display 102. Video output program 116 determines what the interests are of the individuals within group 108 and compares those interests to determine common interests of group 108. Video output program 116 prioritizes the common interests of group 108 and searches video output database 118 for video content that is anticipated to interest one or more individuals within group 108 based on the common interests of group 108. Video display 102 shows the prioritized video content retrieved from video output database 118 to group 108 and determines, by use of camera 104 and biometrics, an estimated level of interest by individuals within group 108 for the displayed video content.

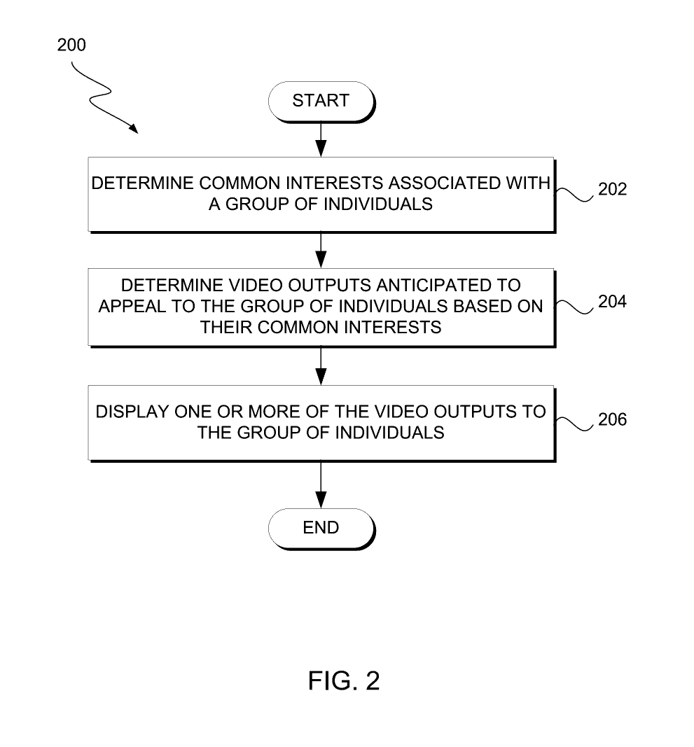

FIG. 2 illustrates operational processes, generally designated 200, for displaying video outputs to a group of individuals (such as group 108) based on their common interests, on a computing device (such as computing device 114) within the environment of FIG. 1, in accordance with an exemplary embodiment of the present invention. In general, a common interest may be an interest shared by two or more individuals or may be an overall area of interest that two different interests belong to. For example, two individuals share an interest in a particular vehicle, their shared interest is that particular vehicle. In another example, individual A has an interest in trees and wildlife while individual B has an interest in camping. Their common interest would therefore include both of those particular interests, such as, for example, a wildlife preserve that has camping and hiking amenities.

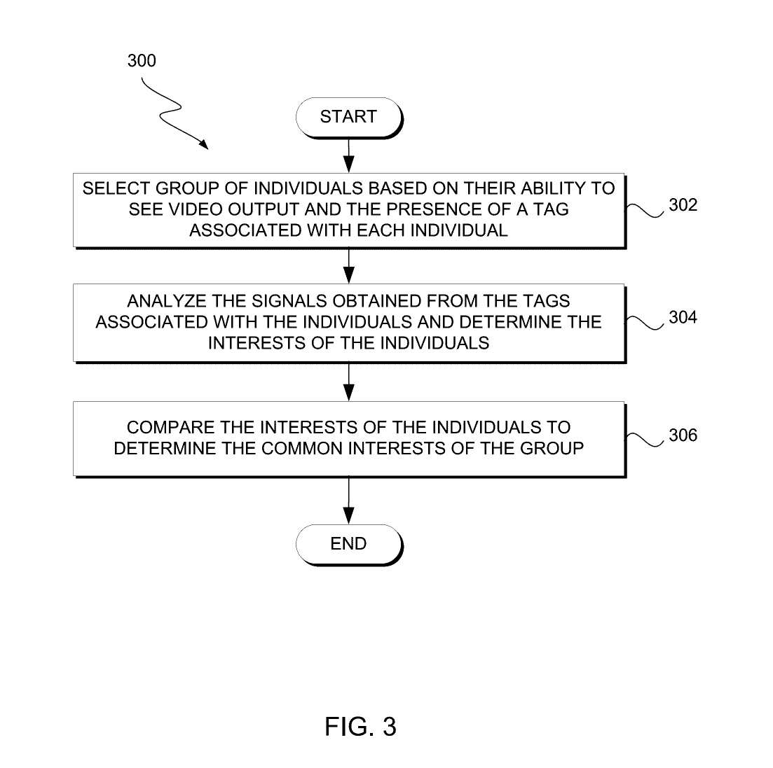

In step 202, video output program 116 determines the common interests associated with a group 108. Possible categories of interests that group 108 have in common include one or more of: providers of goods that individuals within group 108 enjoy frequenting, types of goods that individuals within group 108 enjoy purchasing, service providers that individuals within group 108 enjoy frequenting, types of services that individuals within group 108 enjoy using, entertainment that individuals within group 108 enjoy, travel destinations that individuals within group 108 enjoy, sports that individuals within group 108 enjoy, hobbies that individuals with group 108 enjoy, etc. The processes involved in step 202 are described in more detail in FIG. 3.

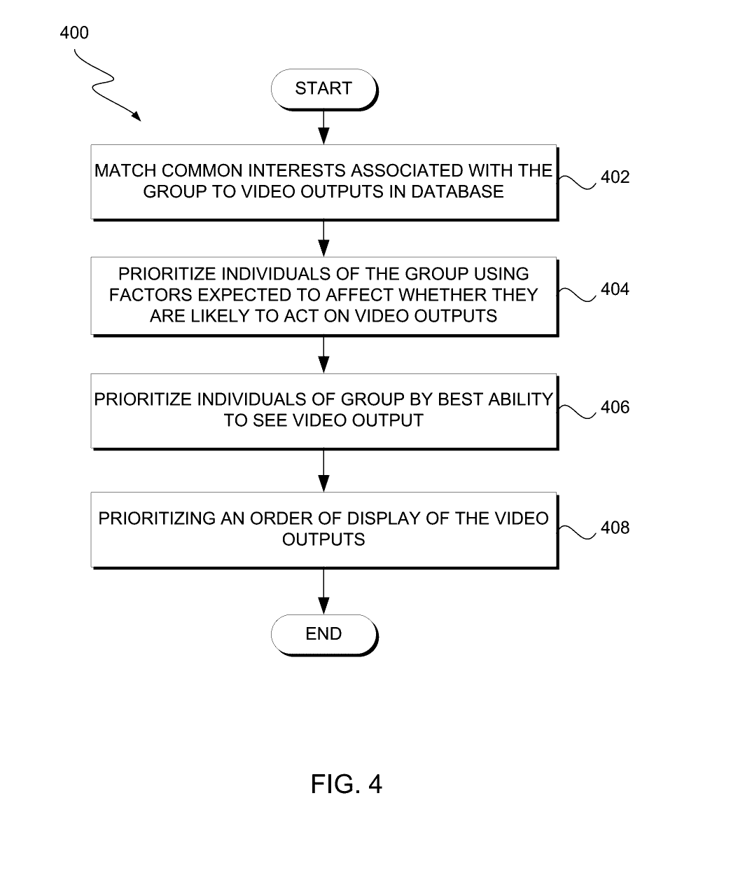

In step 204, video output program 116 determines video outputs anticipated to appeal to group 108 based on their common interests. For example, if a common interest of individuals within group 108 is a provider of goods or services, then at least a portion of the determined video outputs will include an advertisement for the provider or at least reference the provider along with information regarding how to contact the provider. In another example, if a common interest of individuals within group 108 is a type of goods or services, then at least a portion of the determined video outputs will include an advertisement or at least a reference to goods or services of that type along with information regarding how to obtain those goods or services. In a third example, if a common interest of individuals within group 108 is an entertainment interest, then at least a portion of the determined video outputs will include an advertisement or at least a reference to that common entertainment interest along with information regarding how to, for instance, purchase tickets to see the entertainment. In a fourth example, if a common interest of individuals within group 108 is a travel destination or type of travel destination (e.g. ski resort, foreign travel, gambling resort, cruise ship vacation, tropical island, etc.), then at least a portion of the determined video outputs will include an advertisement or at least a reference to that travel destination or type of travel destination along with information such as where to find the nearest travel agent. In a fifth example, if a common interest of individuals within group 108 is a sport or team, then at least a portion of the determined video outputs will include an advertisement or at least a reference to that sport or team along with information such as where and when to tune in a television channel that is televising an event involving that sport or team. The processes involved in step 204 are described in more detail in FIG. 4.

In step 206, video output program 116 displays one or more of the video outputs to the individuals within group 108. In various embodiments, the video outputs will be shown on one or more display screens that can be viewed by group 108 for the entire duration of the video outputs. For example, the video outputs are shown to group 108 as they sit facing video display 102. In another example the video outputs are shown to group 108 as they wander around a large area with an unobstructed view of video display 102. In a third example, group 108 is a group of individuals riding on a people mover or escalator and video display 102 is a series of display screens along the path of group 108. In a fourth example, portions of the video output are send to a series of video display 102 devices such that the individuals within group 108 are able to view an entirety of the video output as they walk around. In some such embodiments, video output program 116 predicts a likely pathway of the individual and sends portions of the video output to the display devices to coincide with the individual coming into viewing range of a given video display 102. In one embodiment, video output program 116 predicts a likely pathway of the individual, based on one or more of known pathways, obstructions, direction and speed of travel for the individual, a destination of the individual, and a mode of transport utilized by the individual. In this embodiment, the individuals within group 108 are able to continuously view the video outputs on each display screen as they pass by it.

Camera 104 tracks the individuals within group 108 and video output program 116 uses biometrics to determine whether the individuals within group 108 are paying attention to the video outputs. For example, if some individuals within group 108 are not looking at video display 102, then video output program 116 determines that those individuals are likely not paying attention to the video outputs. On the other hand, if some individuals within group 108 are slowing down and staring at the video outputs, then video display 102 determines that those individuals are likely interested in the content of the video outputs.

FIG. 3 illustrates operational processes, generally designated 300, for determining the common interests associated with a group of individuals (such as group 108), on a computing device (such as computing device 114) within the environment of FIG. 1, in accordance with an exemplary embodiment of the present invention.

In step 302, video output program 116 selects group 108 based on the ability of the individuals to see the video outputs from video display 102 and whether they have RFID tags such as individual RFID tags 110. Tracking groups of individuals employing cameras (such as camera 104), RFID readers (such as RFID reader 106), and RFID tags (such as individual RFID tags 110) is well known in the art. In various embodiments, video output program 116 uses RFID tracking and biometrics to determine which individuals on camera 104 have RFID tags 110 and whether they can see video display 102. In one embodiment, individual RFID tags 110 are provided to individuals to enable the individuals to enjoy discounts for various goods and services. In order to obtain discounts, the individuals provide the information included on the tags. Information regarding the purchases of the individuals is collected (e.g. what was purchased, cost, etc.) to build profiles indicating the interests of the individuals. In another embodiment, individual RFID tags 110 are components of mobile devices that the individuals within group 108 possess and information regarding their interests is obtained from service providers with the permission of the individuals. In other embodiments, individual RFID tags 110 are components of credit cards that the individuals within group 108 possess and information regarding their interests is obtained from credit card companies with the permission of the individuals.

In step 304, video output program 116 analyzes the signals obtained from individual RFID tags 110 to obtain the information from the tags. In one embodiment, the information is a serial number that identifies the profile of the individual. In another embodiment, the information is a uniform resource identifier (URL) that provides a link to the profile of the individual. In general, the information provided by one of the RFID tags in individual RFID tags 110 is a key that allows video output program 116 to unlock the interests of the individual associated with that RFID tag.

In step 306, video output program 116 compares the interests of the individuals to determine one or more common interests of group 108. For example, individuals that have profiles indicating a fondness for movies result in the creation of a group common interest for movies. Within some general interests are also specific interests. In the above example, a group common interest for movies may be divided into specific common interests such as interests in romances, action movies, science fiction, etc. In another example, several individuals within group 108 eat out creating a group 108 general common interest of restaurants and specific common interests of Japanese, Thai, and Italian restaurants.

It should be understood that a group common interest need not be an interest that the entire group shares. However, the more individuals within group 108 that share an interest, the higher in priority the interest will be (all other factors being equal). This and other factors determine a priority in the order of video outputs by video output program 116.

FIG. 4 illustrates operational processes, generally designated 400, for prioritizing the video outputs displayed to group 108, on a computing device such as computing device 114 within the environment of FIG. 1, in accordance with an exemplary embodiment of the present invention.

In step 402, video output program 116 matches common interests associated with group 108 to video outputs in video output database 118. For example, if there are individuals in group 108 that have common interests pertaining to home improvement projects, then video output program 116 matches that common interest with video outputs such as home improvement shows and advertisements. In a second example, if there are individuals in group 108 that have common interests pertaining to sporting activities, then video output program 116 matches that common interest with video outputs such as sporting events and advertisements for sporting goods.

In step 404, video output program 116 prioritizes individuals within group 108 using factors expected to affect whether the individuals are likely to act on the video outputs. In various embodiments, several factors contribute to the relative importance given one individual in group 108 over another. Factors that are expected to affect whether individuals within group 108 will act on the video outputs include: i) the frequency with which the individual shops, ii) the amount of money the individual typically spends shopping, and iii) the level of activity the user has shown for the subject matter of the video outputs. In various embodiments, the amount of data that exists for an individual within group 108 also factors in their priority.

In step 406, video output program 116 prioritizes the individuals within group 108 according to their ability to see the video outputs. In various embodiments, factors that are expected to affect whether individuals within group 108 will effectively see the video outputs include: i) distance of the individual from video display 102, ii) the horizontal angle of sight of the individual for video display 102, iii) the vertical angle of sight of the individual for video display 102, and iv) whether the individual appears to be busy in a distracting activity such as walking, running, conversation, reading, watching television, focusing on a mobile device, etc.

In step 408, video output program 116 prioritizes an order of display of the video outputs that match the common interests of group 108. In various embodiments, the order of display of the matching video outputs is prioritized by assigning a numeric weight or importance to each individual within group 108 (steps 404 and 406 above), sub-grouping group 108 by common interests that match one or more video outputs in video output database 118, and calculating the numeric weight or importance of each subgroup matched with video outputs. The video outputs that match the most heavily weighted subgroups of group 108 are higher in priority than the lower weighted subgroups.

FIG. 5 depicts a block diagram, 500, of components of computing device 114, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 114 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Video output program 116 and video output database 118 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of network 112. In these examples, communications unit 510 includes one or more network interface cards. Communications unit 510 may provide communications through the use of either or both physical and wireless communications links. Video output program 116 and video output database 118 may be downloaded to persistent storage 508 through communications unit 510.

I/O interface(s) 512 allows for input and output of data with other devices that may be connected to computing device 114. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., video output program 116 and video output database 118, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as “Smalltalk” and the like may be subject to trademark rights in various jurisdictions throughout the world and are used here only in reference to the products or services properly denominated by the marks to the extent that such trademark rights may exist.

What is claimed is:

1. A method comprising:
determining, by one or more processors, a common interest associated with a group of individuals based, at least in part, on one or more interests associated with individuals within the group of individuals;
determining, by one or more processors, a video output to display to the group of individuals, wherein the video output is anticipated to appeal to at least a portion of the group of individuals based, at least in part, on the common interest associated with the group of individuals; and
displaying, by one or more processors, the video output to the group of individuals.

2. The method of claim 1 further comprising:
selecting, by one or more processors, the group of individuals based, at least in part, on whether they are capable of seeing the video output and whether a tag is associated with individuals within the group of individuals;
analyzing, by one or more processors, signals from tags associated with individuals within the group of individuals;
determining, by one or more processors, the one or more interests associated with individuals within the group of individuals based, at least in part, on one or more sources of data identified from the signals; and
comparing, by one or more processors, the one or more interests associated with individuals within the group of individuals.

3. The method of claim 1 further comprising:
matching, by one or more processors, the video output with the common interest associated with the group of individuals;
prioritizing, by one or more processors, individuals within the group of individuals based, at least in part, on 1) one or more factors expected to affect whether an individual within the group of individuals will likely act on the video output and 2) an ease with which the individual within the group of individuals can view the video output; and
prioritizing, by one or more processors, an order of display of the video output.

4. The method of claim 1, wherein the video output is displayed in one or more of: transportation hubs, entertainment venues, and shopping venues.

5. The method of claim 1, wherein the video output is displayed on one or more video displays positioned in one or more following ways: in front of seating areas, alongside people-movers, alongside escalators, and areas where foot traffic is heavy.

6. The method of claim 1, wherein the common interest associated with the group of individuals includes one or more following categories: one or more providers of goods, one or more service providers, one or more types of goods, one or more types of service, entertainment, one or more travel destinations, sports, and hobbies.

7. The method of claim 3, wherein:
the one or more factors expected to affect whether the individual within the group of individuals will likely act on the video output includes one or more of: i) a frequency with which the individual shops, ii) an amount of money the individual typically spends shopping, and iii) a level of activity the individual has shown for a subject matter of the video output; and
the ease with which the individual within the group of individuals can view the video output includes one or more of: i) a distance of the individual from one or more video displays displaying the video output, ii) a horizontal angle of sight of the individual for the one or more video displays, iii) a vertical angle of sight of the individual for the one or more video displays, and iv) whether the individual appears to be distracted by an activity other than the video output.

8. A computer program product comprising:
one or more computer-readable storage media and program instructions stored on at least one of the one or more computer-readable storage media, the program instructions comprising:
program instructions to determine a common interest associated with a group of individuals based, at least in part, on one or more interests associated with individuals within the group of individuals;
program instructions to determine a video output to display to the group of individuals, wherein the video output is anticipated to appeal to at least a portion of the group of individuals based, at least in part, on the common interest associated with the group of individuals; and
program instructions to display the video output to the group of individuals.

9. The computer program product of claim 8 further comprising:
program instructions to select the group of individuals based, at least in part, on whether they are capable of seeing the video output and whether a tag is associated with individuals within the group of individuals;
program instructions to analyze signals from tags associated with individuals within the group of individuals;
program instructions to determine the one or more interests associated with individuals within the group of individuals based, at least in part, on one or more sources of data identified from the signals; and
program instructions to compare the one or more interests associated with individuals within the group of individuals.

10. The computer program product of claim 8 further comprising:
program instructions to match the video output with the common interest associated with the group of individuals;
program instructions to prioritize individuals within the group of individuals based, at least in part, on 1) one or more factors expected to affect whether an individual within the group of individuals will likely act on the video output and 2) an ease with which the individual within the group of individuals can view the video output; and
program instructions to prioritize an order of display of the video output.

11. The computer program product of claim 8, wherein the video output is displayed in one or more of: transportation hubs, entertainment venues, and shopping venues.

12. The computer program product of claim 8, wherein the video output is displayed on one or more video displays positioned in one or more following ways: in front of seating areas, alongside people-movers, alongside escalators, and areas where foot traffic is heavy.

13. The computer program product of claim 8, wherein the common interest associated with the group of individuals includes one or more following categories: one or more providers of goods, one or more service providers, one or more types of goods, one or more types of service, entertainment, one or more travel destinations, sports, and hobbies.

14. The computer program product of claim 10, wherein:
the one or more factors expected to affect whether the individual within the group of individuals will likely act on the video output includes one or more of: i) a frequency with which the individual shops, ii) an amount of money the individual typically spends shopping, and iii) a level of activity the individual has shown for a subject matter of the video output; and
the ease with which the individual within the group of individuals can view the video output includes one or more of: i) a distance of the individual from one or more video displays displaying the video output, ii) a horizontal angle of sight of the individual for the one or more video displays, iii) a vertical angle of sight of the individual for the one or more video displays, and iv) whether the individual appears to be distracted by an activity other than the video output.

15. A computer system comprising:
one or more computer processors;
one or more computer-readable storage media; and
program instructions stored on at least one of the one or more computer-readable storage media for execution by at least one of the one or more processors, the program instructions comprising:
program instructions to determine a common interest associated with a group of individuals based, at least in part, on one or more interests associated with individuals within the group of individuals;
program instructions to determine a video output to display to the group of individuals, wherein the video output is anticipated to appeal to at least a portion of the group of individuals based, at least in part, on the common interest associated with the group of individuals; and
program instructions to display the video output to the group of individuals.

16. The computer system of claim 15 further comprising:
program instructions to select the group of individuals based, at least in part, on whether they are capable of seeing the video output and whether a tag is associated with individuals within the group of individuals;
program instructions to analyze signals from tags associated with individuals within the group of individuals;
program instructions to determine the one or more interests associated with individuals within the group of individuals based, at least in part, on one or more sources of data identified from the signals; and
program instructions to compare the one or more interests associated with individuals within the group of individuals.

17. The computer system of claim 15 further comprising:
program instructions to match the video output with the common interest associated with the group of individuals;
program instructions to prioritize individuals within the group of individuals based, at least in part, on 1) one or more factors expected to affect whether an individual within the group of individuals will likely act on the video output and 2) an ease with which the individual within the group of individuals can view the video output; and
program instructions to prioritize an order of display of the video output.

18. The computer system of claim 15, wherein the video output is displayed in one or more of: transportation hubs, entertainment venues, and shopping venues.

19. The computer system of claim 15, wherein the video output is displayed on one or more video displays positioned in one or more following ways: in front of seating areas, alongside people-movers, alongside escalators, and areas where foot traffic is heavy.

20. The computer system of claim 15, wherein the common interest associated with the group of individuals includes one or more following categories: one or more providers of goods, one or more service providers, one or more types of goods, one or more types of service, entertainment, one or more travel destinations, sports, and hobbies.
